(19) United States
(12) Patent Application Publication
(10) Pub. No.: US 2016/0252833 A1
(43) Pub. Date: Sep. 1, 2016

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Hirofumi Kumoi, Suntou-gun (JP); Masataka Kawahara, Mishima-shi (JP); Masato Tanaka, Tagata-gun (JP)

(21) Appl. No.: 15/055,238

(22) Filed: Feb. 26, 2016

(30) Foreign Application Priority Data
Feb. 27, 2015 (JP) 2015-039417

(51) Int. Cl. G03G 15/00

(52) U.S. Cl. CPC G03G 5/0696; G03G 5/0525; G03G 5/047

(57) ABSTRACT

An electrophotographic photosensitive member includes a support member, a charge generating layer, and a charge transport layer in that order. The charge generating layer contains a gallium phthalocyanine crystal containing therein at least one amide compound selected from the group consisting of N-methylformamide, N-propylformamide, and N-vinylformamide. The charge transport layer contains fluorine-containing resin particles and a fluorine-containing copolymer.

### BACKGROUND OF THE INVENTION

1. Field of the Invention

The present disclosure relates to an electrophotographic photosensitive member, and a process cartridge and an electrophotographic apparatus that include the electrophotographic photosensitive member.

2. Description of the Related Art

An electrophotographic photosensitive member is typically of a function-separated multilayer type in which the functions of charge generation and charge transport are carried out by a charge generating layer and a charge transport layer, respectively.

Since the oscillation wavelength of semiconductor lasers used for exposing images is as long as 650 nm to 820 nm, charge generating materials sensitive to long-wavelength light have been developed as a material having the function of generating charges.

Phthalocyanine pigments are sensitive to light in a long-wavelength region and are accordingly used as charge generating materials. Among the phthalocyanine pigments, oxytitanium phthalocyanine and gallium phthalocyanine are particularly superior in sensitivity to light in a long-wavelength region, and various crystals thereof and improved production processes thereof have been reported.

Japanese Patent Laid-Open No. 7-331107 discloses a hydroxygallium phthalocyanine crystal containing a polar organic solvent. In this patent document, a polar organic solvent, such as N,N-dimethylformamide, is used for transformation so that the molecule thereof is taken into the crystal, and the resulting crystal exhibits satisfactory sensitivity.

Also, the electrophotographic photosensitive member of electrophotographic apparatuses directly receives electrical and mechanical external forces and is accordingly required to be resistant to those external forces. Wear resistance is particularly required. If the wear resistance of an electrophotographic photosensitive member is poor, the sensitivity of the photosensitive member decreases and results in reduced image density, or the chargeability of the photosensitive member is reduced and results in an increased risk of image defects such as fogging. For solving these disadvantages, some approaches are disclosed for improving the wear resistance of the electrophotographic photosensitive member.

For example, Japanese Patent Laid-Open No. 6-332219 discloses a technique for reducing the frictional force on the surface of an electrophotographic photosensitive member, in which tetrafluoroethylene resin particles or any other fluorine-containing resin particles are dispersed in the surface layer of an electrophotographic photosensitive member. In this technique, a dispersant is in combination for dispersing the fluorine-containing resin particles.

### SUMMARY OF THE INVENTION

According to an aspect of the present disclosure, there is provided an electrophotographic photosensitive member including a support member, a charge generating layer, and a charge transport layer in that order. The charge generating layer contains a gallium phthalocyanine crystal containing therein at least one amide compound selected from the group consisting of N-methylformamide, N-propylformamide, and N-vinylformamide. The charge transport layer contains fluorine-containing resin particles and a fluorine-containing copolymer.

According to another aspect of the present disclosure, a process cartridge capable of being removably attached to an electrophotographic apparatus is provided. The process cartridge includes the electrophotographic photosensitive member and at least one device selected from the group consisting of a charging device, a developing device, and a cleaning device. The electrophotographic photosensitive member and the at least one device are held in one body.

According to another aspect of the present disclosure, a process cartridge capable of being removably attached to an electrophotographic apparatus is provided. The process cartridge includes the electrophotographic photosensitive member and at least one device selected from the group consisting of a charging device, a developing device, and a cleaning device. The electrophotographic photosensitive member and the at least one device are held in one body.

Further features of the present invention will become apparent from the following description of exemplary embodiments with reference to the attached drawings.

### BRIEF DESCRIPTION OF THE DRAWINGS

FIG. 1 is a schematic view of the structure of an electrophotographic apparatus provided with a process cartridge including an electrophotographic photosensitive member according to an embodiment of the present disclosure.

FIG. 2 is a powder X-ray diffractogram of hydroxygallium phthalocyanine crystals produced in Example 1-1.

FIG. 3 is a powder X-ray diffractogram of chlorogallium phthalocyanine crystals produced in Example 1-13.

### DESCRIPTION OF THE EMBODIMENTS

Electrophotographic process speed have been being increased, and accordingly, it is desired that high-quality images having no defects be formed even in repeating high-speed processes. In order to respond to increasing electrophotographic process speed, highly sensitive charge-generating materials are used. However the charge-generating layer can easily cause charges to be retained at the interface with the charge transport layer, depending on the structure of the charge transport layer. The present inventors think that the charge generating layer containing particularly a fluoro-graft polymer, which is a dispersant disclosed in Japanese Patent Laid-Open No. 6-332219, causes charges to be retained at the interface with the charge transport layer, thus causing potential fluctuation.

Accordingly, the present disclosure provides an electrophotographic photosensitive member improved so as to be able to form high-quality images by reducing the potential fluctuation occurring after repeating high-speed processes, and a process cartridge and an electrophotographic apparatus that include the electrophotographic photosensitive member.

### Electrophotographic Photosensitive Member

The electrophotographic photosensitive member disclosed herein includes a support member, and a charge generating layer and a charge transport layer that are disposed over the support member. The charge generating layer contains a gallium phthalocyanine crystal containing an organic compound (P). The organic compound (P) is at least one amide compound selected from the group consisting of N-methylformamide, N-propylformamide, and N-vinylformamide. Also, the charge transport layer contains fluorine-containing resin particles and a fluorine-containing copolymer.

The present inventors assume as below the reason why the electrophotographic photosensitive member of the present disclosure has the effect of reducing potential fluctuation at the surface thereof.

The transfer of carriers in the interface between the charge transport layer and the charge generating layer is liable to be affected by a fluorine-containing polymer present close to the interface. In the embodiments disclosed herein, however, the gallium phthalocyanine crystal containing a specific amide compound therein enables the interface between the charge transport layer containing a fluorine-containing copolymer and the charge generating layer to function considerably advantageously for charge transfer. It is thought that the retention of charges is thus reduced to reduce potential fluctuation.

The proportion of the organic compound (P) to the gallium phthalocyanine in the gallium phthalocyanine crystal is desirably in the range of 0.1% by mass to 3.0% by mass, and more desirably in the range of 0.3% by mass to 1.5% by mass. When the proportion of the organic compound (P) is in such a range, potential fluctuation can be further reduced.

The organic compound (P) may be a combination of a plurality of organic compounds. If a plurality of organic compounds are used as the organic compound (P), the content of the organic compound (P) is the total content of the organic compounds.

Advantageously, the organic compound (P) is N-methylformamide from the viewpoint of reducing potential fluctuation.

The gallium phthalocyanine crystal may be any one of hydroxygallium phthalocyanine crystal, chlorogallium phthalocyanine crystal, bromogallium phthalocyanine crystal, and iodogallium phthalocyanine crystal. These have high sensitivity and are accordingly effective in achieving the subject matter of the present disclosure. In particular, hydroxygallium phthalocyanine crystal and chlorogallium phthalocyanine crystal are advantageous. The molecule of hydroxygallium phthalocyanine crystals has a hydroxy group as an axial ligand of the central gallium atom. The molecule of chlorogallium phthalocyanine crystals has a chlorine atom as an axial ligand of the central gallium atom. The molecule of bromogallium phthalocyanine crystal has a bromine atom as an axial ligand as the central gallium atom. The molecule of iodogallium phthalocyanine crystal has an iodine atom as an axial ligand of the central gallium atom.

A hydroxygallium phthalocyanine crystal whose CuKα X-ray diffractogram shows peaks at Bragg angle 2θ of 7.4°±0.3° and 28.3°±0.3° is more advantageous in view of sensitivity.

Also, a chlorogallium phthalocyanine crystal whose CuKα X-ray diffractogram shows peaks at Bragg angle 2θ of 7.4°±0.2°, 16.6°±0.2°, 25.5°±0.2°, and 28.3°±0.2° is more advantageous in view of sensitivity.

A process for producing a gallium phthalocyanine crystal containing an organic compound (P) therein will now be described.

The gallium phthalocyanine crystal is produced in the step of transforming gallium phthalocyanine into a crystalline form by wet milling. In this step, the wet milling of the gallium phthalocyanine is performed in a solvent containing the organic compound (P). Advantageously, the gallium phthalocyanine to be subjected to wet milling is produced by acid pasting or dry milling, and more advantageously by acid pasting.

The wet milling mentioned herein is a treatment performed in a milling device, such as a sand mill or a ball mill, with dispersing media, such as glass beads, steal beads, or alumina balls. The wet milling may be performed for about 30 hours to 3000 hours. Advantageously, an aliquot is sampled every 10 to 100 hours, and the content of the organic compound (P) in the gallium phthalocyanine crystal is checked by ¹H-NMR. The mass of the dispersing aid used for the wet milling may be 10 to 50 times that of the gallium phthalocyanine.

The mass of the organic compound (P) to be used is desirably 5 to 30 times that of the gallium phthalocyanine crystal.

The content of the organic compound (P) in the gallium phthalocyanine crystal can be determined by ¹H-NMR analysis of the gallium phthalocyanine crystal.

The X-ray diffraction and ¹H-NMR analysis of the gallium phthalocyanine crystal used in the electrophotographic photosensitive member of the present disclosure are performed under the following conditions:

### Powder X-Ray Diffraction

Apparatus: X-ray diffractometer RINT-TTR II, manufactured by Rigaku
X-ray tube: Cu
Tube voltage: 50 kV
Tube current: 300 mA
Scanning: 2θ/θ scan
Scanning speed: 4.0°/min
Sampling interval: 0.02°
Start angle (2θ): 5.0°
Stop angle (2θ): 40.0°
Attachment: Standard sample holder
Filter: not used
Incident monochromator: used
Counter monochromator: not used
Divergence slit: open
Divergence vertical limit slit: 10.00 mm
Scattering slit: open
Receiving slit: open
Flat monochromator: used
Counter: Scintillation counter

### ¹H-NMR Analysis

Analyzer: AVANCE III 500, manufactured by BRUKER
Measuring nuclide: ¹H
Solvent: bisulfuric acid (D₂SO₄)
Number of integrations: 2000

### Photosensitive Layer

The charge generating layer containing a gallium phthalocyanine crystal containing the organic compound (P) therein and the charge transport layer containing fluorine-containing resin particles and a fluorine-containing copolymer define a multilayer photosensitive layer of the electrophotographic photosensitive member disclosed herein. The charge generating layer underlies the charge transport layer. In the following description, the gallium phthalocyanine crystal containing an organic compound (P) therein may be referred to as the organic compound (P)-containing gallium phthalocyanine crystal.

### Charge Generating Layer

The charge generating layer may be formed by applying onto a surface a coating liquid prepared by dispersing the organic compound (p)-containing gallium phthalocyanine crystals and a binding resin in a solvent, and drying the coating film.

The thickness of the charge generating layer is desirably in the range of 0.05 μm to 1 μm, such as in the range of 0.1 μm to 0.3 μm.

The content of the organic compound (P)-containing gallium phthalocyanine crystal in the charge generating layer is desirably in the range of 40% to 85% by mass, such as in the range of 60% to 80% by mass, relative to the total mass of the charge generating layer.

The binding resin in the charge generating layer may be selected from among polyester, acrylic resin, polycarbonate, polyvinyl butyral, polystyrene, polyvinyl acetate, polysulfone, acrylonitrile copolymers, poly(vinyl benzal), and the like. From the viewpoint of dispersing the gallium phthalocyanine crystals, polyvinyl butyral or poly(vinyl benzal) is suitable.

The solvent used in the coating liquid for the charge generating layer may be an alcohol-based solvent, a sulfoxide-based solvent, a ketone-based solvent, an ether-based solvent, an ester-based solvent, or an aromatic hydrocarbon.

### Charge Transport Layer

The charge transport layer contains fluorine-containing resin particles and a fluorine-containing copolymer in addition to a binding resin.

The fluorine-containing resin particles may be particles of tetrafluoroethylene resin, trifluoroethylene resin, tetrafluoroethylene-hexafluoropropylene resin, vinyl fluoride resin, vinylidene fluoride resin, or ethylene dichloride difluoride resin. Particles of a copolymer of these resins may be used. From the viewpoint of being satisfactorily dispersed in the surface of the electrophotographic photosensitive member, tetrafluoroethylene resin particles are advantageous.

In addition, from the viewpoint of satisfactorily dispersing the fluorine-containing resin particles, the fluorine-containing copolymer contained in the charge transport layer desirably has a structural unit expressed by the following formula (1) and a structural unit expressed by formula (2):

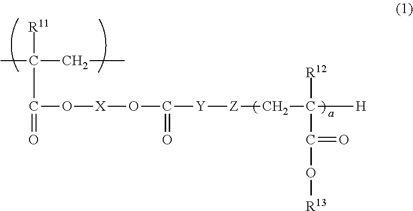

In formula (1), a represents an integer of 1 or greater; R¹¹, R¹², and R¹³ each represent one of a hydrogen atom and alkyl groups; X and Y each represent one of a single bond, a bonding group expressed by formula (3), or a bonding group expressed by formula (4); and Z represents one selected from the group consisting of a sulfur atom, an oxygen atom, a nitrogen atom, a single bond, and a bonding group expressed by formula (3). If Z represents a nitrogen atom, an atom or a group may be bound to the nitrogen atom.

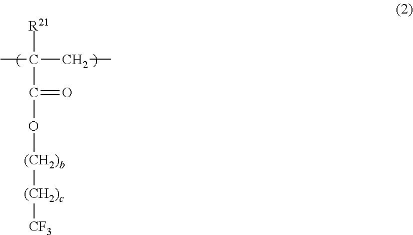

In formula (2), b represents an integer of 0 or greater; c represents an integer in the range of 1 to 7; and R²¹ represents one of a hydrogen atom and alkyl groups.

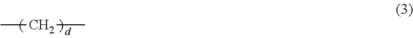

In formulas (3), d represents an integer of 0 or greater.

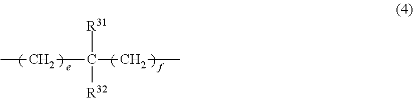

In formula (4), e and f each represent an integer of 0 or greater. R³¹ and R³² each represent a hydrogen atom, a halogen atom, a hydroxy group, a substituted or unsubstituted alkyl group, or a substituted or unsubstituted aryl group.

c in formula (2) is desirably an integer in the range of 2 to 6, such as in the range of 4 to 6, from the viewpoint of dispersing the fluorine-containing resin particles.

The fluorine-containing copolymer can be synthesized by a known process, such as the process disclosed in Japanese Patent Laid-Open No. 2009-104145.

The fluorine-containing copolymer having the structural units expressed by formulas (1) and (2) functions as a dispersant capable of dispersing the fluorine-containing resin particles as particles having a particle size close to that of primary particles and maintaining the state of such fine particles.

The charge transport layer can be formed by applying a coating liquid prepared by dissolving a charge transport material and a binding resin in a solvent to form a coating film and drying the coating film. This coating liquid for the charge transport layer contains the fluorine-containing resin particles and the fluorine-containing copolymer in addition to the charge transport material and the binding resin. The fluorine-containing resin particles and the fluorine-containing copolymer may be dispersed in the same solvent as the solvent that is the main constituent of the coating liquid for the charge transport layer and then added to the coating liquid. The fluorine-containing resin particles and the fluorine-containing copolymer can be dispersed by using, for example, a homogenizer, an ultrasonic disperser, a ball mill, a sand mill, an attritor, or a high-speed liquid collision disperser.

The solvent used for forming the charge transport layer may be selected from among the following solvents: ketones, such as acetone and methyl ethyl ketone; esters, such as methyl acetate and ethyl acetate; aromatic hydrocarbons, such as toluene, xylene, and chlorobenzene; ethers, such as 1,4-dioxane and tetrahydrofuran; and halogen-substituted hydrocarbons, such as chloroform. These solvents may be used singly or in combination.

Aromatic hydrocarbons, such as toluene, xylene, and chlorobenzene, are suitable from the viewpoint of satisfactorily dissolving the charge transport material and the binding resin. In view of environmental protection, toluene and xylene are advantageous. The solvent may be used in combination with a low-boiling temperature solvent, such as dimethoxymethane or tetrahydrofuran from the viewpoint of uniformly forming the coating film.

The average primary particle size of the fluorine-containing resin particles is desirably in the range of 0.05 μm to 0.85 μm, such as 0.05 μm to 0.40 μm, from the viewpoint of reducing the frictional force on the surface of the electrophotographic photosensitive member while maintaining the electrophotographic properties. The average primary particle size of the fluorine-containing resin particles mentioned herein is the value measured with an ultracentrifugation particle size distribution analyzer CAPA-700 (manufactured by Horiba). For the measurement with CAPA-700, more specifically, the fluorine-containing resin particles and the fluorine-containing polymer are mixed and dispersed in each other, and this dispersion liquid is immediately subjected to particle size measurement in accordance with the instruction manual of the analyzer before being mixed with the coating liquid for the charge transport layer.

Advantageously, the content of the fluorine-containing resin particles is in the range of 0.1% by mass to 30.0% by mass relative to the total mass of the charge transport material and the binding resin. Desirably, it is in the range of 3.0% by mass to 15.0% by mass.

The proportion of the fluorine-containing copolymer to the fluorine-containing resin particles is desirably in the range of 1.0% by mass to 15.0% by mass, such as in the range of 1.0% by mass to 10.0% by mass, from the viewpoint of satisfactorily dispersing the fluorine-containing resin particles.

Advantageously, the fluorine-containing copolymer has a weight average molecular weight Mw in the range of 60,000 to 400,000, and the Mw/Mn ratio of the weight average molecular weight (Mw) thereof to the number average molecular weight (Mn) thereof is in the range of 2.0 to 8.0. More advantageously, the weight average molecular weight Mw is in the range of 60,000 to 300,000 and the Mw/Mn ratio is in the range of 2.0 to 7.0. The fluorine-containing copolymer having such molecular weights helps disperse the fluorine-containing resin particles satisfactorily.

The weight average molecular weight and number average molecular weight of the fluorine-containing copolymer mentioned herein are polystyrene-equivalent molecular weights measured by a conventional method as below. More specifically, a copolymer to be measured is added to tetrahydrofuran and allowed to stand for several hours, and then the copolymer and the tetrahydrofuran are mixed well while being shaken, followed by being allowed to stand for another 12 hours or more. Then, the mixture is passed through a sample treatment filter Maishori Disk H-25-5 manufactured by Tosoh to prepare a gel permeation chromatography (GPC) sample. Subsequently, a column is stabilized in a heat chamber of 40° C., and 10 μL of the GPC sample is introduced to the column of this temperature with a solvent tetrahydrofuran flowing at a rate of 0.35 mL/min. Thus the molecular weight of the copolymer is measured. The column is Tosoh column TSK gel Super HZ-H. For measuring the molecular weight of a sample, the molecular weight distribution of the sample is estimated from the relationship between the logarithm of the molecular weight and the number of counts of a calibration curve prepared using some types of monodisperse polystyrene microspheres as reference materials. A refractive index (RI) detector is used as the detector.

The thickness of the charge transport layer is desirably in the range of 5 μm to 40 μm, such as in the range of 7 μm to 25 μm.

The charge transport material content in the charge transport layer is desirably in the range of 20% to 80% by mass, such as in the range of 30% to 50% by mass, relative to the total mass of the charge transport layer.

Exemplary charge transport materials include triarylamine compounds, hydrazone compounds, stilbene compounds, pyrazoline compounds, oxazole compounds, thiazole compounds, and triallylmethane compounds. Triarylamine compounds are more suitable as the charge transport material.

The binding resin used in the charge transport layer can be selected from among acrylic resin, styrene resin, polyester resin, polycarbonate resin, polyacrylate resin, polysulfone resin, polyphenylene oxide resin, epoxy resin, polyurethane resin, and alkyd resin.

The charge transport layer may further contain a releasing agent to increase the transfer efficiency of the toner, or a filler to prevent scraping.

### Support Member

The support member of the electrophotographic photosensitive member disclosed herein is desirably electrically conductive (electroconductive support member). For example, the support member may be made of a metal or an alloy, such as aluminum or stainless steel, or may be a metal, alloy, plastic, or paper member provided with an electrically conductive layer thereon. The shape thereof may be cylindrical or film-like.

### Undercoat Layer

In an embodiment, an undercoat layer (may be called an intermediate layer) may be provided between the support member and the photosensitive layer. The undercoat layer functions as a barrier and an adhesive.

The undercoat layer may be made of polyvinyl alcohol, polyethylene oxide, ethyl cellulose, methyl cellulose, casein, or polyamide. The undercoat layer can be formed by applying a coating liquid containing such an undercoat layer material on the support member to form a coating film, and drying the coating film. A metal oxide may be added as a resistance control agent.

The undercoat layer may have a thickness in the range of 0.3 μm to 5.0 μm.

The undercoat layer may further contain an electron transport material. Such an undercoat layer can further reduce the potential fluctuation caused by fatigue resulting from repeating high-speed processes. This is probably because the electron transport material improves the electron mobility between the charge generating layer and the undercoat layer and thus helps the carriers at the interface between the charge transport layer and the charge generating layer to move to come in a more advantageous state. The undercoat layer containing an electron transport material may be such that it contains a polymer produced by polymerizing a composition containing an isocyanate compound, a resin, and an electron transport material. The electron transport material may be an imide compound, and is desirably a naphthyldiimide compound.

### Electroconductive Layer

Furthermore, an electroconductive layer may be disposed between the support member and the undercoat layer. This is advantageous for covering the irregularity of or defects in the support member and preventing interference fringes.

The electroconductive layer can be formed by dispersing electrically conductive particles, such as carbon black or metal particles, in a binding resin.

The thickness of the electroconductive layer is desirably in the range of 5 μm to 40 μm, such as in the range of 10 μm to 30 μm.

The coating liquid for each layer may be applied by dipping, spray coating, spinner coating, bead coating, blade coating, beam coating, or any other coating technique.

### Process Cartridge and Electrophotographic Apparatus

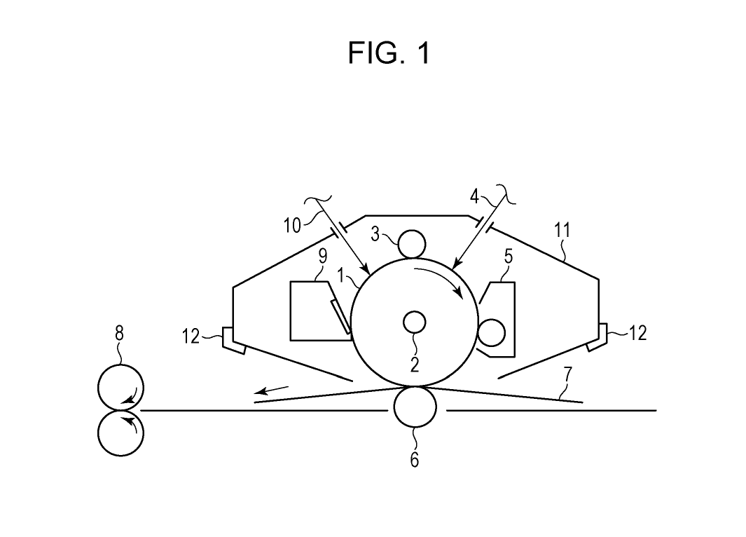

FIG. 1 is a schematic view of the structure of an electrophotographic apparatus provided with a process cartridge including an electrophotographic photosensitive member according to an embodiment of the present disclosure.

This electrophotographic photosensitive member 1, which is cylindrical (drum-shaped), is driven for rotation on a in the direction indicated by an arrow at a predetermined peripheral speed (process speed).

When driven for rotation, the surface of the electrophotographic photosensitive member 1 is charged to a predetermined positive or negative potential with a charging device 3. Subsequently, an electrostatic latent image corresponding to desired image information is formed on the surface of the charged electrophotographic photosensitive member 1 by irradiation with exposure light 4 from an exposure device (not shown). The exposure light 4 has been modulated in intensity according to the time-series electric digital image signals of desired image information output from an image exposure device, such as a slit exposure device or a laser beam scanning exposure device.

The electrostatic latent image formed on the surface of the electrophotographic photosensitive member 1 is developed (normally developed or reversely developed) into a toner image with a toner contained in a developing device 5. The toner image on the surface of the electrophotographic photosensitive member 1 is transferred to a transfer medium 7 by a transfer device 6. At this time, a bias voltage having an opposite polarity to the charge of the toner is applied to the transfer device 6 from a bias source (not shown). When the transfer medium 7 is paper, it is fed to the portion between the electrophotographic photosensitive member 1 and the transfer device 6 from a paper feeder (not shown) in synchronization with the rotation of the electrophotographic photosensitive member 1.

The transfer medium 7 to which the toner image has been transferred from the electrophotographic photosensitive member 1 is separated from the surface of the electrophotographic photosensitive member 1 and conveyed to a fixing device 8 for fixing the toner image, thus being ejected as an image-formed article (printed matter or copy).

The surface of the electrophotographic photosensitive member 1 from which the toner image has been transferred to the transfer medium 7 is cleaned with a cleaning device 9 to remove therefrom the toner or the like remaining after transfer. In recent years, some cleaning systems have been developed so that the toner remaining after transfer can be directly removed by a developing device or the like. Then, the surface of the electrophotographic photosensitive member 1 is pre-exposed to pre-exposure light 10 from a pre-exposure device (not shown) to remove static electricity before being repeatedly used for forming images. If the charging device 3 is a contact charging type using a charging roller or the like, pre-exposure device is not necessarily required.

Some of the components of the electrophotographic apparatus including the electrophotographic photosensitive member 1, the charging device 3, the developing device 5, and the cleaning device 9 may be integrated in a container as a process cartridge. The process cartridge may be removably mounted to the body of an electrophotographic apparatus. For example, at least one selected from among the charging device 3, the developing device 5, and the cleaning device 9 is integrated with the electrophotographic photosensitive member 1 into a cartridge. The cartridge may be guided by a guide 12 such as a rail, thus being used as a process cartridge 11 removable from the body of the electrophotographic apparatus.

If the electrophotographic apparatus is a copy machine or a printer, the exposure light 4 may be reflected light from or transmitted light through an original image. Alternatively, the exposure light 4 may be light emitted by laser beam scanning operation according to the signals generated by reading the original image with a sensor, or light emitted from an LED array or a liquid crystal shutter array driven according to such signals.

The speed of the electrophotographic process including charging, exposure, development, and transfer is represented by a cycle time. The cycle time refers to the time (seconds) required for one cycle of the electrophotographic process of the electrophotographic photosensitive member. In the embodiments disclosed herein, the cycle time is set to 0.4 s or less from the viewpoint of responding to the recent demand for high-speed processes.

The electrophotographic photosensitive member 1 disclosed herein can be widely applied to electrophotographic applications, such as the fields of laser beam printers, CRT printers, LED printers, FAX machines, liquid crystal printers, and laser plate making.

### EXAMPLES

The subject matter of the present disclosure will be further described in detail with reference to specific examples. It is however not limited to the disclosed examples. The thicknesses of each layer of the electrophotographic photosensitive members of the Examples and Comparative Examples were determined by measurement using an eddy current thickness meter Fischerscope (manufactured by Fischer Technology) or by calculation using specific gravity and mass per unit area. In the following description, the term “part(s)” refers to “part(s) by mass” and “%” refers to percent by mass.

### Synthesis of Gallium Phthalocyanine Pigment

### Synthesis Examples 1

A reactor was charged with 5.46 parts of phthalonitrile and 45 parts of α-chloronaphthalene and was then heated to and kept at 30° C. in an atmosphere of nitrogen flow. Subsequently, 3.75 parts of gallium trichloride was added at this temperature (30° C.) to the reactor. The water content in the resulting mixture was 150 ppm. Then, the mixture was heated to 200° C. Subsequently, the mixture was subjected to a reaction at 200° C. for 4.5 hours in an atmosphere of nitrogen flow, followed by cooling to 150° C. Then, the reaction product was filtered out. The resulting filtration product was dispersed in N,N-dimethylformamide for washing at 140° C. for 2 hours, followed by filtration. The resulting filtration product was washed with methanol and dried to yield 4.65 parts of a chlorogallium phthalocyanine pigment (yield: 71%).

### Synthesis Examples 2

In 139.5 parts of concentrated sulfuric acid was dissolved at 10° C. 4.65 parts of the chlorogallium phthalocyanine pigment produced in Synthesis Example 1. While being stirred, the solution was dropped into 620 parts of ice water for precipitation, and the precipitate was filtered using a filter press. The resulting wet cake (filtration product) was dispersed in 2% ammonia solution for washing and then filtered using a filter press. Subsequently, the resulting wet cake (filtration product) was dispersed in ion exchanged water for washing and filtered using a filter press. This operation was repeated three times to yield a hydrous hydroxygallium phthalocyanine pigment having a solid content of 23%.

Subsequently, 6.6 kg of the resulting hydrous hydroxygallium phthalocyanine pigment was dried as below in a dryer HYPER-DRY HD-06R (product name, oscillation frequency: 2455 MHz±15 MHz, manufactured by Biocon).

The hydrous hydroxygallium phthalocyanine pigment in the state of cake taken out of the filter press (hydrous cake thickness: 4 cm or less) was placed on a dedicated circular plastic tray, and the dryer was set so that the internal wall temperature would be 50° C. and that infrared radiation would be off. For microwave irradiation, the vacuum pump and the leakage valve were adjusted so that the degree of vacuum was set to 4.0 kPa to 10.0 kPa.

In the first step of the drying, the hydroxygallium phthalocyanine pigment was irradiated with microwaves of 4.8 kW for 50 minutes. Then, after temporarily interrupting microwave radiation, the dryer was evacuated to a high vacuum of 2 kPa or less with the leakage valve closed. At this time, the solid content of the hydroxygallium phthalocyanine pigment was 88%.

Subsequently, in the second step, the degree of vacuum (internal pressure of the dryer) was adjusted to the above-set range (4.0 kPa to 10.0 kPa) by adjusting the leakage valve, and the hydroxygallium phthalocyanine pigment was irradiated with microwaves of 1.2 kW for 5 minutes. After temporarily interrupting the microwaves radiation again, the dryer was evacuated to a high vacuum of 2 kPa or less with the leakage valve closed. This second step was repeated once (total twice). At this time, the solid content of the hydroxygallium phthalocyanine pigment was 98%.

Furthermore, in the third step, irradiation with microwaves was performed in the same manner as in the second step, except that the power of the microwaves was varied from 1.2 kW to 0.8 kW. This third step was repeated once (total twice).

Furthermore, in the fourth step, the degree of vacuum (internal pressure of the dryer) was returned to the above-set range (4.0 kPa to 10.0 kPa) by adjusting the leakage valve adjusted, and the hydroxygallium phthalocyanine pigment was irradiated with microwaves of 0.4 kW for 3 minutes. Then, after temporarily interrupting microwave radiation, the dryer was evacuated to a high vacuum of 2 kPa or less with the leakage valve closed. This fourth step was repeated seven times (total eight times).

Thus, 1.51 kg of hydroxygallium phthalocyanine pigment with a water content of 1% or less was produced over a period of three hours in total.

### Examples 1-1 to 1-11 and Comparative Examples 1-1 and 1-2 Example 1-1

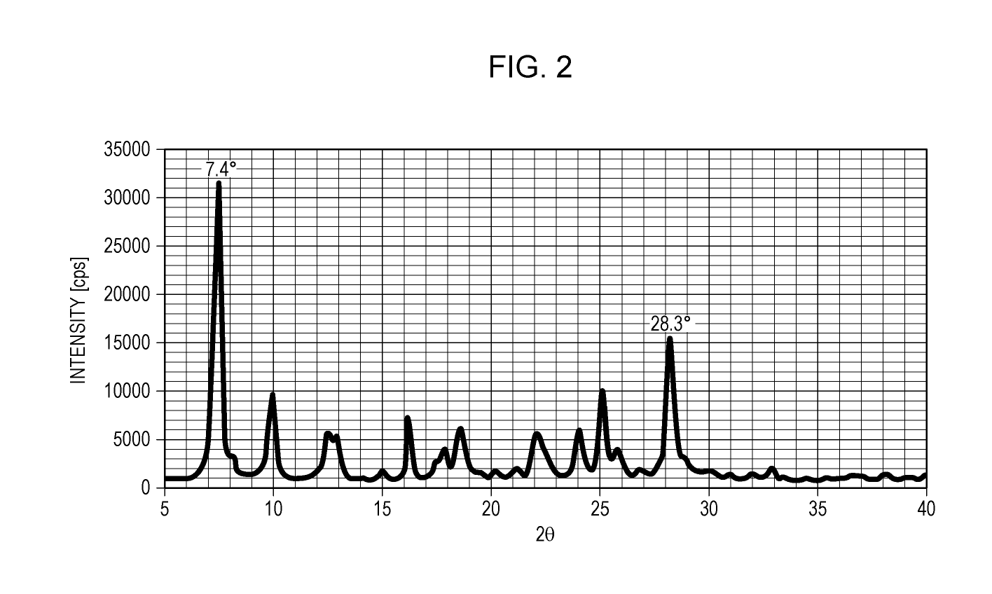

In a ball mill, 0.5 part of the hydroxygallium phthalocyanine pigment produced in synthesis Example 2 and 10 parts of N-methylformamide were subjected to wet milling treatment with 20 parts of glass beads of 0.8 mm in diameter at room temperature (23° C.) and 120 rpm for 200 hours. After removing the glass beads from the resulting dispersion liquid by decantation, the dispersion liquid was filtered, and the filtration product remaining in the filter was fully washed with tetrahydrofuran. Then, the resulting filtration product was vacuum-dried to yield 0.43 part of hydroxygallium phthalocyanine crystals. FIG. 2 shows a powder X-ray diffractogram of the resulting crystals.

Also, the result of calculation using the proton ratio obtained by ¹H-NMR analysis showed that the hydroxygallium phthalocyanine crystals contained N-methylformamide with a proportion of 1.2% by mass relative to the hydroxygallium phthalocyanine in the hydroxygallium phthalocyanine crystals. Since N-methylformamide is miscible with tetrahydrofuran, this result suggests that the N-methylformamide is confined in the crystals.

### Example 1-2

The same process as in Example 1-1 was performed to yield 0.44 part of hydroxygallium phthalocyanine crystals, except that the wet milling time was varied from 200 hours to 1000 hours. The powder X-ray diffractogram of the resulting hydroxygallium phthalocyanine crystals was similar to FIG. 2.

Also, the result of calculation using the proton ratio obtained by ¹H-NMR analysis showed that the hydroxygallium phthalocyanine crystals contained N-methylformamide with a proportion of 0.5% by mass relative to the hydroxygallium phthalocyanine in the hydroxygallium phthalocyanine crystals.

### Example 1-3

The same process as in Example 1-1 was performed to yield 0.41 part of hydroxygallium phthalocyanine crystals, except that the wet milling time was varied from 200 hours to 100 hours. The powder X-ray diffractogram of the resulting hydroxygallium phthalocyanine crystals was similar to FIG. 2.

Also, the result of calculation using the proton ratio obtained by ¹H-NMR analysis showed that the hydroxygallium phthalocyanine crystals contained N-methylformamide with a proportion of 2.1% by mass relative to the hydroxygallium phthalocyanine in the hydroxygallium phthalocyanine crystals.

### Example 1-4

The same process as in Example 1-1 was performed to yield 0.43 part of hydroxygallium phthalocyanine crystals, except that 10 parts of N-methylformamide was replaced with 10 parts of N-n-propylformamide and that the wet milling time was varied from 200 hours to 500 hours.

The powder X-ray diffractogram of the resulting hydroxygallium phthalocyanine crystals was similar to FIG. 2.

Also, the result of calculation using the proton ratio obtained by ¹H-NMR analysis showed that the hydroxygallium phthalocyanine crystals contained N-n-propylformamide with a proportion of 1.5% by mass relative to the hydroxygallium phthalocyanine in the hydroxygallium phthalocyanine crystals.

### Example 1-5

The same process as in Example 1-4 was performed to yield 0.40 part of hydroxygallium phthalocyanine crystals, except that the wet milling time was varied from 500 hours to 1000 hours. The powder X-ray diffractogram of the resulting hydroxygallium phthalocyanine crystals was similar to FIG. 2.

Also, the result of calculation using the proton ratio obtained by ¹H-NMR analysis showed that the hydroxygallium phthalocyanine crystals contained N-n-propylformamide with a proportion of 0.9% by mass relative to the hydroxygallium phthalocyanine in the hydroxygallium phthalocyanine crystals.

### Example 1-6

The same process as in Example 1-4 was performed to yield 0.44 part of hydroxygallium phthalocyanine crystals, except that the wet milling time was varied from 500 hours to 50 hours. The powder X-ray diffractogram of the resulting hydroxygallium phthalocyanine crystals was similar to FIG. 2.

Also, the result of calculation using the proton ratio obtained by ¹H-NMR analysis showed that the hydroxygallium phthalocyanine crystals contained N-n-propylformamide with a proportion of 0.4% by mass relative to the hydroxygallium phthalocyanine in the hydroxygallium phthalocyanine crystals.

### Example 1-7

The same process as in Example 1-1 was performed to yield 0.43 part of hydroxygallium phthalocyanine crystals, except that 10 parts of N-methylformamide was replaced with 10 parts of N-vinylformamide and that the wet milling time was varied from 200 hours to 600 hours. The powder X-ray diffractogram of the resulting hydroxygallium phthalocyanine crystals was similar to FIG. 2.

Also, the result of calculation using the proton ratio obtained by ¹H-NMR analysis showed that the hydroxygallium phthalocyanine crystals contained N-vinylformamide with a proportion of 1.5% by mass relative to the hydroxygallium phthalocyanine in the hydroxygallium phthalocyanine crystals. Since N-vinylformamide is miscible with tetrahydrofuran, this result suggests that the N-vinylformamide is confined in the crystals.

### Example 1-8

The same process as in Example 1-7 was performed to yield 0.45 part of hydroxygallium phthalocyanine crystals, except that the wet milling time was varied from 600 hours to 1000 hours. The powder X-ray diffractogram of the resulting hydroxygallium phthalocyanine crystals was similar to FIG. 2.

Also, the result of calculation using the proton ratio obtained by ¹H-NMR analysis showed that the hydroxygallium phthalocyanine crystals contained N-vinylformamide with a proportion of 1.0% by mass relative to the hydroxygallium phthalocyanine in the hydroxygallium phthalocyanine crystals.

### Example 1-9

The same process as in Example 1-7 was performed to yield 0.42 part of hydroxygallium phthalocyanine crystals, except that the wet milling time was varied from 600 hours to 100 hours. The powder X-ray diffractogram of the resulting hydroxygallium phthalocyanine crystals was similar to FIG. 2.

Also, the result of calculation using the proton ratio obtained by ¹H-NMR analysis showed that the hydroxygallium phthalocyanine crystals contained N-vinylformamide with a proportion of 2.1% by mass relative to the hydroxygallium phthalocyanine in the hydroxygallium phthalocyanine crystals.

### Example 1-10

The same process as in Example 1-4 was performed to yield 0.41 part of hydroxygallium phthalocyanine crystals, except that the wet milling time was varied from 500 hours to 200 hours. The powder X-ray diffractogram of the resulting hydroxygallium phthalocyanine crystals was similar to FIG. 2.

Also, the result of calculation using the proton ratio obtained by ¹H-NMR analysis showed that the hydroxygallium phthalocyanine crystals contained N-n-propylformamide with a proportion of 2.4% by mass relative to the hydroxygallium phthalocyanine in the hydroxygallium phthalocyanine crystals.

### Example 1-11

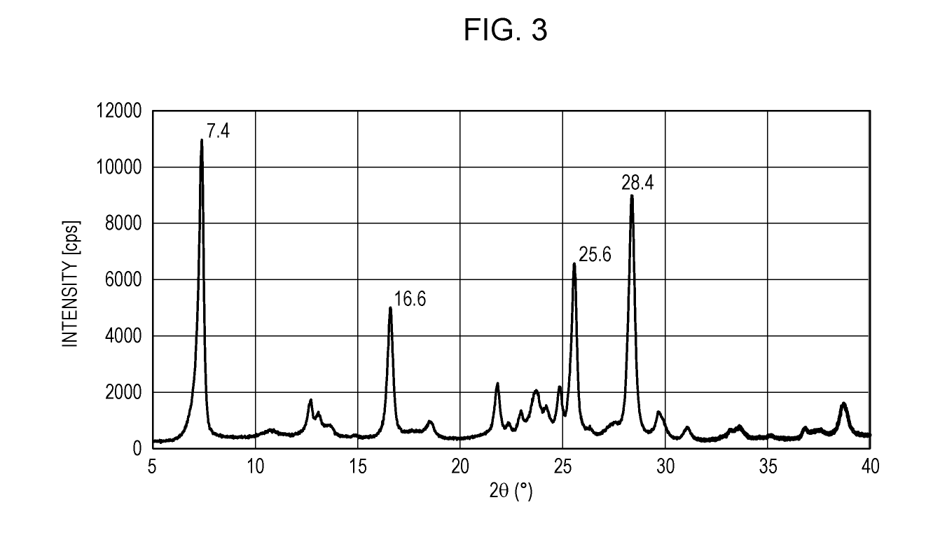

Wet milling treatment of 0.5 part of the chlorogallium phthalocyanine pigment produced in Synthesis Example 1 and 10 parts of N-methylformamide was performed with a magnetic stirrer at room temperature (23° C.) for 4 hours. Chlorogallium phthalocyanine crystals were separated out of the resulting dispersion liquid by filtration using a filter. The chlorogallium phthalocyanine crystals remaining on the filter were fully washed with tetrahydrofuran. Then, the resulting filtration product was vacuum-dried to yield 0.45 part of chlorogallium phthalocyanine crystals. FIG. 3 shows a powder X-ray diffractogram of the resulting crystals.

Also, the result of calculation using the proton ratio obtained by ¹H-NMR analysis showed that the hydroxygallium phthalocyanine crystals contained N-methylformamide with a proportion of 0.4% by mass relative to the hydroxygallium phthalocyanine in the hydroxygallium phthalocyanine crystals.

### Comparative Example 1-1

The same process as in Example 1-1 was performed to yield 0.45 part of hydroxygallium phthalocyanine crystals, except that 10 parts of N-methylformamide was replaced with 10 parts of N,N-dimethylformamide and that the wet milling time was varied from 200 hours to 48 hours.

Also, the result of calculation using the proton ratio obtained by ¹H-NMR analysis showed that the hydroxygallium phthalocyanine crystals contained N,N-dimethylformamide with a proportion of 2.1% by mass relative to the hydroxygallium phthalocyanine in the hydroxygallium phthalocyanine crystals.

### Comparative Example 1-2

The same process as in Example 1-1 was performed to yield 0.42 part of hydroxygallium phthalocyanine crystals, except that 10 parts of N-methylformamide was replaced with 10 parts of dimethyl sulfoxide and that the wet milling time was varied from 200 hours to 48 hours.

Also, the result of calculation using the proton ratio obtained by ¹H-NMR analysis showed that the hydroxygallium phthalocyanine crystals contained dimethyl sulfoxide with a proportion of 2.1% by mass relative to the hydroxygallium phthalocyanine in the hydroxygallium phthalocyanine crystals.

### Examples 2-1 to 2-17 and Comparative Examples 2-1 and 2-4 Example 2-1

In a ball mill were dispersed 60 parts of tin oxide-coated barium sulfate particles (PASTRAN PC1, produced by “Mitsui Mining & Smelting), 15 parts of tin oxide particles (TITANIX JR, produced by Tayca), 43 parts of resol-type phenol resin (PHENOLITE J-325, produced by DIC, solid content: 70% by mass), 0.015 part of silicone oil (SH28PA, produced by Toray Silicone), 3.6 parts of silicone resin (TOSPEARL 120, produced by Toshiba Silicone), 50 parts of 2-methoxy-1-propanol, and 50 parts of methanol for 25 hours to yield a coating liquid for the electroconductive layer.

This coating liquid was applied to the surface of an aluminum cylinder used as the support member by dipping. The resulting coating film was dried at 140° C. for 30 hour to yield a 17 μm thick electroconductive layer.

Subsequently, 10 parts of copolymerized nylon resin (Amilan CM8000, produced by Toray) and 30 parts of methoxymethylated 6-nylon resin (Tresin EF-30T, produced by Teikoku Chemical) were dissolved in a mixed solvent of 400 parts of methanol and 200 parts of n-butanol to yield a coating liquid for forming an undercoat layer.

This coating liquid was applied to the surface of the electroconductive layer by dipping. The resulting coating film was dried to yield a 0.6 μm thick undercoat layer.

Subsequently, a sand mill was charged with 10 parts of the hydroxygallium phthalocyanine crystals (charge generating material) produced in Example 1-1, 5 parts of a polyvinyl butyral (S-LEC BX-1, produced by Sekisui Chemical), 200 parts of cyclohexanone, and 400 parts of glass beads of 1 mm in diameter. The materials were subjected to dispersion for 4 hours. The resulting dispersion liquid was diluted to yield a coating liquid for forming a charge generating layer by adding 90 parts of cyclohexanone and 300 parts of ethyl acetate.

The resulting coating liquid was applied onto the undercoat layer by dipping. The resulting coating film was dried at 100° C. for 10 minutes to yield a 0.25 μm thick charge generating layer.

Subsequently, a mixture was prepared of 5 parts of tetrafluoroethylene resin particles (Lubron L-2, produced by Daikin Industries), 5 parts of polycarbonate resin (Iupizeta PCZ-400, produced by Mitsubishi Gas Chemical), 0.25 part of fluorine-containing copolymer having structural units expressed by the following formulas (1-1) and (2-1) (Mw=90,000, Mw/Mn=3.5, a=60), and 70 parts of xylene. The mixture was subjected to dispersion at a pressure of 49 MPa twice with a high-speed liquid collision disperser (Microfluidizer M-110EH, manufactured by Microfluidics) to yield a dispersion liquid of tetrafluoroethylene resin particles. The tetrafluoroethylene resin particles in the resulting dispersion liquid had an average primary particle size of 0.24 μm.

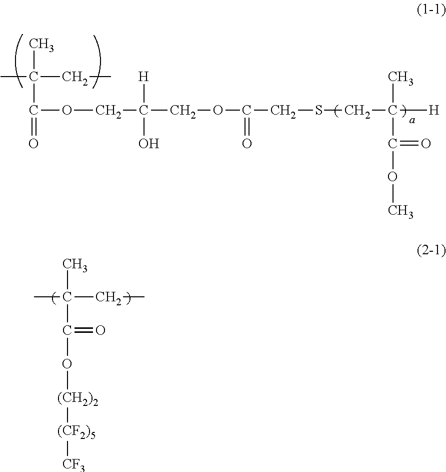

Subsequently, a solution containing charge transport materials was prepared by dissolving the following materials in 60 parts of xylene and 40 parts of dimethoxymethane:

Compound (charge transport material) expressed by formula (CTM-1): 8 parts;

Compound (charge transport material) expressed by formula (CTM-2): 1 part; and Polycarbonate resin (Iupizeta PCZ-400, produced by Mitsubishi Gas Chemical): 10 parts.

The above-prepared dispersion liquid of tetrafluoroethylene resin particles was added to and mixed with this solution to yield a coating liquid for the charge transport layer. The amount of the dispersion liquid of the tetrafluoroethylene resin particles was adjusted so that the proportion of the tetrafluoroethylene resin particles would be 5% by mass relative to the total mass of the charge transport materials and the polycarbonate resin in the coating liquid.

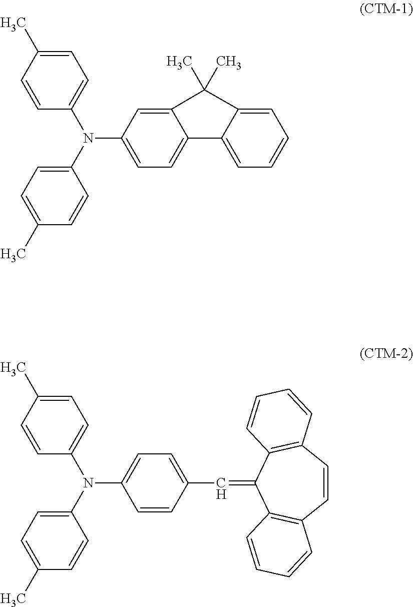 [SMILES: Cc1ccc(N(c2ccc(C)cc2)c2ccc3c(c2)C(C)(C)c2ccccc2-3)cc1 ; Cc1ccc(N(c2ccc(C)cc2)c2ccc(C=C3c4ccccc4C=Cc4ccccc43)cc2)cc1]

The coating liquid for the charge transport layer was applied onto the surface of the charge generating layer by dipping. The resulting coating film was dried at 125° C. for 40 minutes to yield an 18 μm thick charge transport layer. Thus, an electrophotographic photosensitive member of the present Example was completed.

### Evaluations

### Evaluation of Unevenness in Density

For evaluating the resulting electrophotographic photosensitive member, images output after the photosensitive member had been repeatedly used were tested. For the evaluation, a laser beam printer P 4510 (manufactured by Hewlett-Packard was used. The driving and control systems of the laser beam printer were modified so that the cycle time of the printer would be 0.25 s.

First, the electrophotographic photosensitive member was mounted to the process cartridge of the laser beam printer, and the laser beam printer was placed in an environment of a temperature of 32° C. and a relative humidity of 80%. After 20 hours had passed since the placement, evaluation was performed in the same environment as below.

First, horizontal lines each having a width equivalent to two dots were successively output at intervals of 1 cm in an image output direction on 10,000 A4 sheets. The operations of forming such a line pattern on each A4 sheet were performed at intervals of 5 seconds. Then, a half-tone image was output, and this image was checked for unevenness in density resulting from insufficient dispersion, friction, potential fluctuation, or the like. The image quality was rated according to the following criteria:

A: Unevenness in density was not found.
B: A very small unevenness in density was observed.
C: A small unevenness was observed, but did not affect the image quality.
D: A distinct unevenness in density was observed.
E: A distinct unevenness in density and a streak were found.

### Evaluation of Potential Fluctuation

Then, potential fluctuation after repeating use was examined as below.

For the examination, the same laser beam printer as above was used. For measuring potential, the developing roller, the toner container and the cleaning blade were removed from the process cartridge of the laser beam printer, and a potential measuring probe was attached to the position from which the developing roller had been removed. Then, the electrophotographic photosensitive member was mounted to this process cartridge modified for measuring potential and was placed in an environment of a temperature of 32° C. and a relative humidity of 80% with the body of the laser beam printer. After 20 hours had passed since the placement, the transfer roller was removed from the laser beam printer, and printing operation was started for measuring potential in the same environment without feeding paper.

First, after the entire surface of the sample was exposed, the potential of the sample, which was adjusted so as to be −550 V after being charged, was measured as the potential before durability test. Subsequently, charging and exposure were continuously repeated 5,000 times, and then the potential of the sample, which was adjusted so as to be −550 V after being charged, was measured as the potential after durability test. The difference between the potentials before and after durability test was determined as the potential fluctuation. Table 1 shows the results of the evaluations.

### Example 2-2

An electrophotographic photosensitive member was produced and evaluated in the same manner as in Example 2-1, except that the fluorine-containing copolymer used for preparing the dispersion liquid of tetrafluoroethylene resin particles was replaced with a fluorine-containing copolymer having the structural units expressed by formulas (1-2) and (2-2) (Mw=100,000, Mw/Mn=4.1, a=60). The tetrafluoroethylene resin particles in the dispersion liquid thereof had an average primary particle size of 0.25 m. Table 1 shows the results of the evaluations.

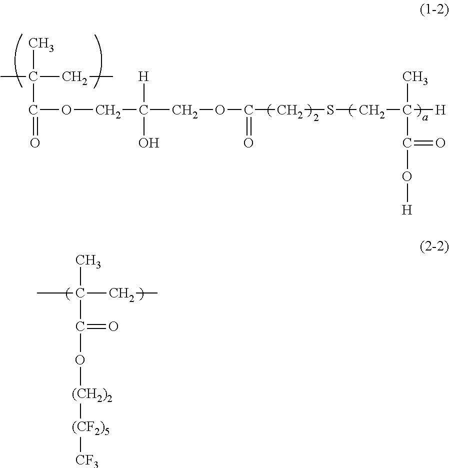

### Example 2-3

An electrophotographic photosensitive member was produced and evaluated in the same manner as in Example 2-1, except that the hydroxygallium phthalocyanine crystals used for preparing the coating liquid for the charge generating layer was replaced with the hydroxygallium phthalocyanine crystals produced in Example 1-2, and that the amount of fluorine-containing copolymer in the dispersion liquid of tetrafluoroethylene resin particles was varied to 0.35 part. The tetrafluoroethylene resin particles in the dispersion liquid thereof had an average primary particle size of 0.19 μm. Table 1 shows the results of the evaluations.

### Example 2-4

An electrophotographic photosensitive member was produced and evaluated in the same manner as in Example 2-1, except that the hydroxygallium phthalocyanine crystals used for preparing the coating liquid for the charge generating layer was replaced with the hydroxygallium phthalocyanine crystals produced in Example 1-3. Table 1 shows the results of the evaluations.

### Example 2-5

An electrophotographic photosensitive member was produced and evaluated in the same manner as in Example 2-1, except that the hydroxygallium phthalocyanine crystals used for preparing the coating liquid for the charge generating layer was replaced with the hydroxygallium phthalocyanine crystals produced in Example 1-4. Table 1 shows the results of the evaluations.

### Example 2-6

An electrophotographic photosensitive member was produced and evaluated in the same manner as in Example 2-1, except that the hydroxygallium phthalocyanine crystals used for preparing the coating liquid for the charge generating layer was replaced with the hydroxygallium phthalocyanine crystals produced in Example 1-4, and that the fluorine-containing copolymer used for preparing the dispersion liquid of tetrafluoroethylene resin particles was replaced with a fluorine-containing copolymer having the structural units expressed by formulas (1-3) and (2-3) (Mw=200,000, Mw/Mn=7.0, a=60). The tetrafluoroethylene resin particles in the dispersion liquid thereof had an average primary particle size of 0.36 μm. Table 1 shows the results of the evaluations.

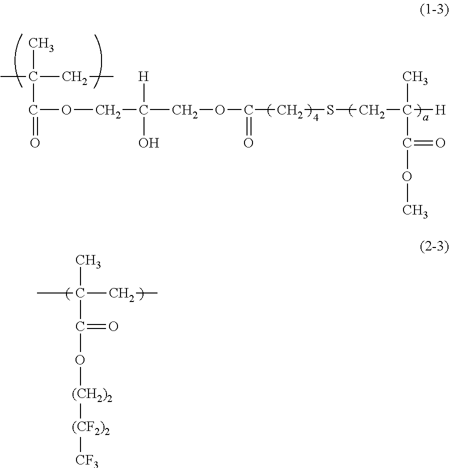

### Example 2-7

An electrophotographic photosensitive member was produced and evaluated in the same manner as in Example 2-1, except that the hydroxygallium phthalocyanine crystals used for preparing the coating liquid for the charge generating layer was replaced with the hydroxygallium phthalocyanine crystals produced in Example 1-5. Table 1 shows the results of the evaluations.

### Example 2-8

An electrophotographic photosensitive member was produced and evaluated in the same manner as in Example 2-1, except that the hydroxygallium phthalocyanine crystals used for preparing the coating liquid for the charge generating layer was replaced with the hydroxygallium phthalocyanine crystals produced in Example 1-6. Table 1 shows the results of the evaluations.

### Example 2-9

An electrophotographic photosensitive member was produced and evaluated in the same manner as in Example 2-1, except that the hydroxygallium phthalocyanine crystals used for preparing the coating liquid for the charge generating layer was replaced with the hydroxygallium phthalocyanine crystals produced in Example 1-7. Table 1 shows the results of the evaluations.

### Example 2-10

The hydroxygallium phthalocyanine crystals used in Example 2-1 for preparing the coating liquid for the charge generating layer was replaced with the hydroxygallium phthalocyanine crystals produced in Example 1-7. Also, the fluorine-containing copolymer used for preparing the dispersion liquid of tetrafluoroethylene resin particles was replaced with a fluorine-containing copolymer having the structural units expressed by formulas (1-4) and (2-4) (Mw=50,000, Mw/Mn=2.5, a=40).

Furthermore, the amount of the fluorine-containing copolymer was varied to 0.15 part. An electrophotographic photosensitive member was thus produced and evaluated in the same manner as in Example 2-1 in other respects. The tetrafluoroethylene resin particles in the dispersion liquid thereof had an average primary particle size of 0.60 μm. Table 1 shows the results of the evaluations.

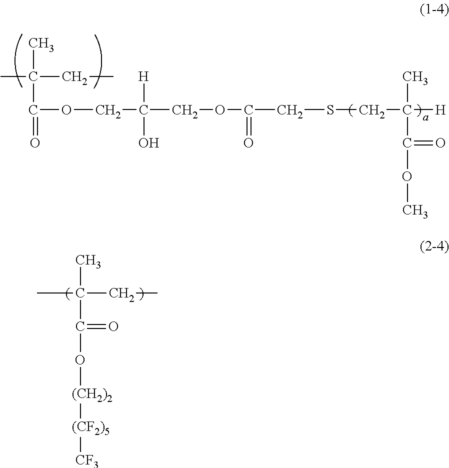

### Example 2-11

The hydroxygallium phthalocyanine crystals used in Example 2-1 for preparing the coating liquid for the charge generating layer was replaced with the hydroxygallium phthalocyanine crystals produced in Example 1-8. Also, the fluorine-containing copolymer used for preparing the dispersion liquid of tetrafluoroethylene resin particles was replaced with a fluorine-containing copolymer having the structural units expressed by formulas (1-5) and (2-5) (Mw=120,000, Mw/Mn=4.9, a=20). Furthermore, the amount of the fluorine-containing copolymer was varied to 0.5 part, and the amount of the dispersion liquid of the tetrafluoroethylene resin particles, added to prepare the coating liquid for the charge transport layer was adjusted so that the proportion of the tetrafluoroethylene resin particles would be 7% by mass relative to the total mass of the charge transport material and the polycarbonate resin in the coating liquid. An electrophotographic photosensitive member was thus produced and evaluated in the same manner as in Example 2-1 in other respects. The tetrafluoroethylene resin particles in the dispersion liquid thereof had an average primary particle size of 0.25 μm. Table 1 shows the results of the evaluations.

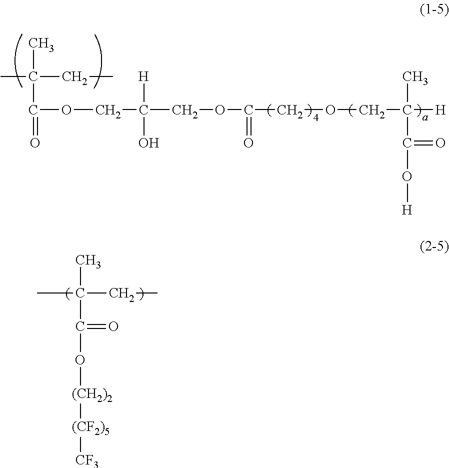

### Example 2-12

The hydroxygallium phthalocyanine crystals used in Example 2-1 for preparing the coating liquid for the charge generating layer was replaced with the hydroxygallium phthalocyanine crystals produced in Example 1-9. Also, the fluorine-containing copolymer used for preparing the dispersion liquid of tetrafluoroethylene resin particles was replaced with a fluorine-containing copolymer having the structural units expressed by formulas (1-6) and (2-6) (Mw=300,000, Mw/Mn=8.2, a=60). Furthermore, the amount of the fluorine-containing copolymer was varied to 0.6 part, and the dispersion with the high-speed liquid collision disperser was performed three times. Furthermore, the amount of the dispersion liquid of the tetrafluoroethylene resin particles, added to prepare the coating liquid for the charge transport layer was adjusted so that the proportion of the tetrafluoroethylene resin particles would be 10% by mass relative to the total mass of the charge transport material and the polycarbonate resin in the coating liquid. An electrophotographic photosensitive member was thus produced and evaluated in the same manner as in Example 2-1 in other respects. The tetrafluoroethylene resin particles in the dispersion liquid thereof had an average primary particle size of 0.11 μm. Table 1 shows the results of the evaluations.

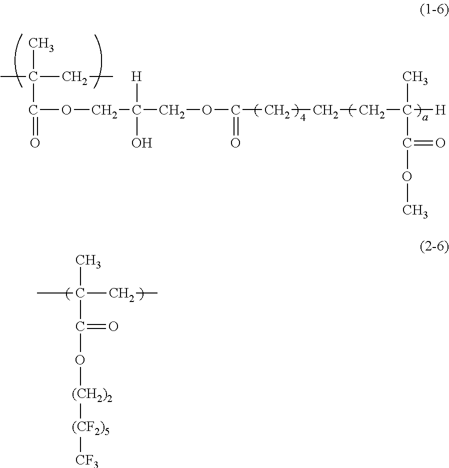

### Example 2-13

An electrophotographic photosensitive member was thus produced and evaluated in the same manner as in Example 2-1, except that the undercoat layer was formed as below.

The following materials were dissolved in the mixed solvent of 100 parts of 1-methoxy-2-propanol and 100 parts of tetrahydrofuran:

10 parts of electron transport material expressed by the following formula (E-1):

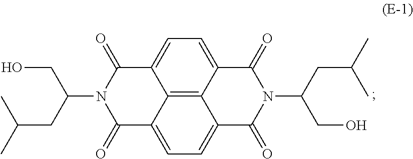 [SMILES: CC(C)CC(CO)N1C(=O)c2ccc3c4c(ccc(c24)C1=O)C(=O)N(C(CO)CC(C)C)C3=O]

13.5 parts of an isocyanate compound (SBN-70D, produced by Asahi Kasei Chemicals);

1.5 parts of a resin, polyvinyl acetal resin (KS-5Z, produced by Sekisui Chemical); and

0.05 part of a catalyst, zinc (II) hexanoate (produced by Mitsuwa Chemicals).

To the resulting solution was added 3.3 parts of a slurry of colloidal silica having an average primary particle size of 9 nm to 15 nm dispersed in an organic solvent (IPA-ST-UP, produced by Nissan Chemical Industries) as an additive, and the mixture was stirred for 1 hours to yield a coating liquid for the undercoat layer.

This coating liquid was applied onto the electroconductive layer by dipping. The resulting coating film was cured by being heated at 160° C. for 45 minutes to yield a 0.5 μm thick undercoat layer.

Table 1 shows the results of the evaluations.

### Example 2-14

The electron transport material used in Example 2-13 for preparing the coating liquid for the undercoat layer was replaced with the electron transport material expressed by the following formula (E-2):

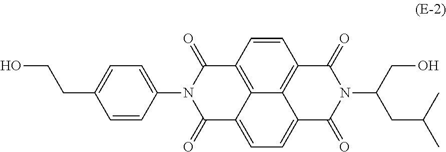 [SMILES: CC(C)CC(CO)N1C(=O)c2ccc3c4c(ccc(c24)C1=O)C(=O)N(c1ccc(CCO)cc1)C3=O]

Also, the hydroxygallium phthalocyanine crystals for preparing the coating liquid for the charge generating layer was replaced with the hydroxygallium phthalocyanine crystals produced in Example 1-4. An electrophotographic photosensitive member was thus produced and evaluated in the same manner as in Example 2-13 in other respects. Table 1 shows the results of the evaluations.

### Example 2-15

The electron transport material used in Example 2-13 for preparing the coating liquid for the undercoat layer was replaced with the electron transport material expressed by the following formula (E-3):

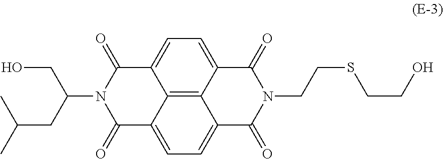 [SMILES: CC(C)CC(CO)N1C(=O)c2ccc3c4c(ccc(c24)C1=O)C(=O)N(CCSCCO)C3=O]

Also, the hydroxygallium phthalocyanine crystals for preparing the coating liquid for the charge generating layer was replaced with the hydroxygallium phthalocyanine crystals produced in Example 1-7. Furthermore, the fluorine-containing copolymer used for preparing the dispersion liquid of tetrafluoroethylene resin particles was replaced with a fluorine-containing copolymer having the structural units expressed by formulas (1-7) and (2-7) (Mw=110,000, Mw/Mn=5.0, a=60). An electrophotographic photosensitive member was thus produced and evaluated in the same manner as in Example 2-13 in other respects. The tetrafluoroethylene resin particles in the dispersion liquid thereof had an average primary particle size of 0.22 μm. Table 1 shows the results of the evaluations.

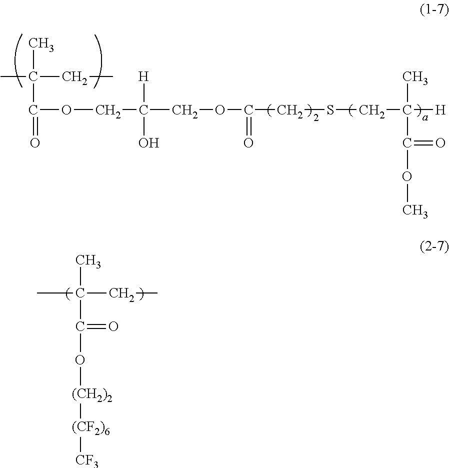

### Example 2-16

The hydroxygallium phthalocyanine crystals used in Example 2-1 for preparing the coating liquid for the charge generating layer was replaced with the hydroxygallium phthalocyanine crystals produced in Example 1-10. Also, the fluorine-containing copolymer used for preparing the dispersion liquid of tetrafluoroethylene resin particles was replaced with a fluorine-containing copolymer having the structural units expressed by formulas (1-8) and (2-8) (Mw=200,000, Mw/Mn=7.0, a=60). Also, the amount of the fluorine-containing copolymer was varied to 0.05 part. Furthermore, the amount of the dispersion liquid of the tetrafluoroethylene resin particles, added to prepare the coating liquid for the charge transport layer was adjusted so that the proportion of the tetrafluoroethylene resin particles would be 3% by mass relative to the total mass of the charge transport material and the polycarbonate resin in the coating liquid. An electrophotographic photosensitive member was thus produced and evaluated in the same manner as in Example 2-1 in other respects. The tetrafluoroethylene resin particles in the dispersion liquid thereof had an average primary particle size of 0.85 μm. Table 1 shows the results of the evaluations.

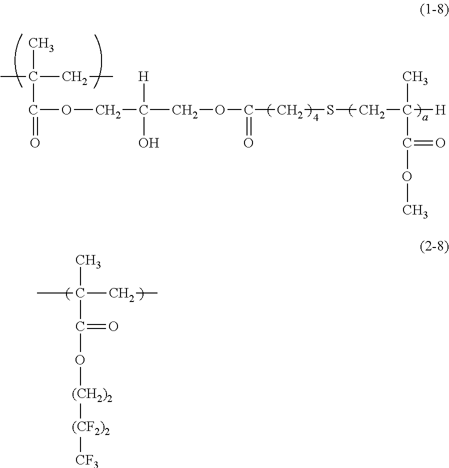

### Example 2-17

The hydroxygallium phthalocyanine crystals used in Example 2-1 for preparing the coating liquid for the charge generating layer was replaced with the chlorogallium phthalocyanine crystals produced in Example 1-11. Also, the fluorine-containing copolymer used for preparing the dispersion liquid of tetrafluoroethylene resin particles was replaced with a fluorine-containing copolymer having the structural units expressed by formulas (1-9) and (2-9) (Mw=110,000, Mw/Mn=5.0, a=60). An electrophotographic photosensitive member was thus produced and evaluated in the same manner as in Example 2-1 in other respects. The tetrafluoroethylene resin particles in the dispersion liquid thereof had an average primary particle size of 0.22 μm. Table 1 shows the results of the evaluations.

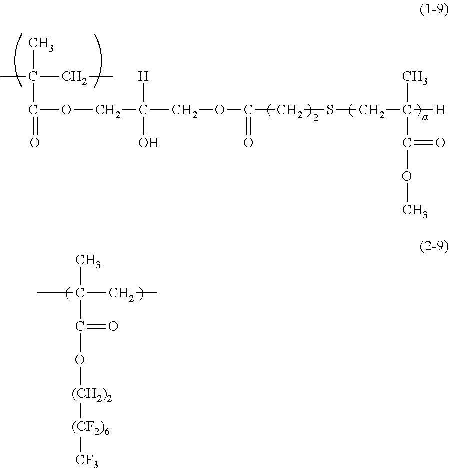

### COMPARATIVE EXAMPLE 2-1

The hydroxygallium phthalocyanine crystals used in Example 2-1 for preparing the coating liquid for the charge generating layer was replaced with the hydroxygallium phthalocyanine crystals produced in Comparative Example 1-1. Also, a fluorine-containing copolymer was not used in the dispersion liquid of tetrafluoroethylene resin particles. An electrophotographic photosensitive member was thus produced and evaluated in the same manner as in Example 2-1 in other respects. The tetrafluoroethylene resin particles in the dispersion liquid thereof had an average primary particle size of 2.33 μm. Table 1 shows the results of the evaluations.

### Comparative Example 2-2

The hydroxygallium phthalocyanine crystals used in Example 2-1 for preparing the coating liquid for the charge generating layer was replaced with the hydroxygallium phthalocyanine crystals produced in Comparative Example 1-2. Also, the fluorine-containing copolymer used in the dispersion liquid of tetrafluoroethylene resin particles was replaced with 0.05 part of a fluorosurfactant Surflon S-611 (produced by AGC Seimi Chemical). Furthermore, the amount of the dispersion liquid of the tetrafluoroethylene resin particles, added to prepare the coating liquid for the charge transport layer was adjusted so that the proportion of the tetrafluoroethylene resin particles would be 3% by mass relative to the total mass of the charge transport material and the polycarbonate resin in the coating liquid. An electrophotographic photosensitive member was thus produced and evaluated in the same manner as in Example 2-1 in other respects. The tetrafluoroethylene resin particles in the dispersion liquid thereof had an average primary particle size of 1.90 μm. Table 1 shows the results of the evaluations.

### Comparative Example 2-3

The hydroxygallium phthalocyanine crystals used in Example 2-1 for preparing the coating liquid for the charge generating layer was replaced with the hydroxygallium phthalocyanine crystals produced in Comparative Example 1-1. Also, in the preparation of the dispersion liquid of tetrafluoroethylene resin particles, tetrafluoroethylene resin particles were not used, and the fluorine-containing copolymer was replace with a fluorine-containing copolymer having the structural units expressed by formulas (1-10) and (2-10). An electrophotographic photosensitive member was thus produced and evaluated in the same manner as in Example 2-1 in other respects. Table 1 shows the results of the evaluations. In the present Comparative Example, the fluorine-containing copolymer having the structural units expressed by formulas (1-10) and (2-10) was Mw=350,000 Mw/Mn=8.4, and a=60.

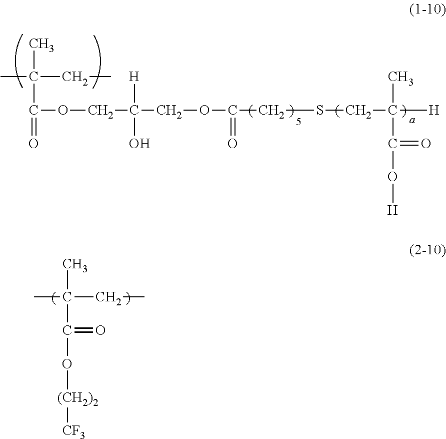

### Comparative Example 2-4

The hydroxygallium phthalocyanine crystals used in Example 2-1 for preparing the coating liquid for the charge generating layer was replaced with the hydroxygallium phthalocyanine crystals produced in Comparative Example 1-2. Also, the fluorine-containing copolymer used for preparing the dispersion liquid of tetrafluoroethylene resin particles was replaced with a fluorine-containing copolymer having the structural units expressed by formulas (1-11) and (2-11) (Mw=500,000, Mw/Mn=10.3, a=60). Furthermore, the amount of the dispersion liquid of the tetrafluoroethylene resin particles, added to prepare the coating liquid for the charge transport layer was adjusted so that the proportion of the tetrafluoroethylene resin particles would be 3% by mass relative to the total mass of the charge transport material and the polycarbonate resin in the coating liquid. An electrophotographic photosensitive member was thus produced and evaluated in the same manner as in Example 2-1 in other respects. The tetrafluoroethylene resin particles in the dispersion liquid thereof had an average primary particle size of 0.90 m. Table 1 shows the results of the evaluations.

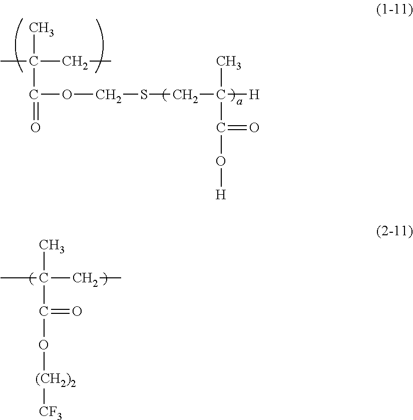

TABLE 1

| | Initial potential | Potential after durability | Potential | Image |
|---|---|---|---|---|
| | (-V) | test (-V) | fluctuation (V) | rating |
| Example 2-1 | 142 | 160 | 18 | A |
| Example 2-2 | 145 | 168 | 23 | A |
| Example 2-3 | 150 | 179 | 29 | A |
| Example 2-4 | 147 | 172 | 25 | B |
| Example 2-5 | 145 | 165 | 20 | A |
| Example 2-6 | 141 | 167 | 26 | C |
| Example 2-7 | 137 | 157 | 20 | A |
| Example 2-8 | 145 | 168 | 23 | B |
| Example 2-9 | 140 | 159 | 19 | A |
| Example 2-10 | 142 | 163 | 21 | B |
| Example 2-11 | 144 | 174 | 30 | B |
| Example 2-12 | 149 | 183 | 34 | B |
| Example 2-13 | 137 | 149 | 12 | A |
| Example 2-14 | 136 | 146 | 10 | A |
| Example 2-15 | 140 | 153 | 13 | A |
| Example 2-16 | 146 | 170 | 24 | C |
| Example 2-17 | 135 | 150 | 15 | A |
| Comparative Example | 155 | 195 | 40 | E |
| 2-1 | | | | |
| Comparative Example | 174 | 259 | 85 | D |
| 2-2 | | | | |
| Comparative Example | 146 | 226 | 80 | E |
| 2-3 | | | | |
| Comparative Example | 152 | 202 | 50 | E |
| 2-4 | | | | |

In Examples 2-1 to 2-17, the tetrafluoroethylene resin particles were satisfactorily dispersed. The electrophotographic photosensitive members of these Examples exhibited reduced potential fluctuation and produced high-quality images even after being repeatedly used in a high-speed process electrophotographic apparatus.

On the other hand, the photosensitive member of Comparative Example 2-1 produced images having unevenness resulting from poor dispersion of tetrafluoroethylene resin particles. Also, the photosensitive members of Comparative Examples 2-2 to 2-4 produced images having unevenness and scrapes resulting from not only poor dispersion of tetrafluoroethylene resin particles, but also potential fluctuation after being repeatedly used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-039417, filed Feb. 27, 2015, which is hereby incorporated by reference herein in its entirety.

What is claimed is:

1. An electrophotographic photosensitive member comprising in the following order:
a support member;
a charge generating layer containing a gallium phthalocyanine crystal containing therein at least one amide compound selected from the group consisting of N-methylformamide, N-propylformamide, and N-vinylformamide; and
a charge transport layer containing fluorine-containing resin particles and a fluorine-containing copolymer.

2. The electrophotographic photosensitive member according to claim 1, wherein the fluorine-containing resin particles are resin particles comprising a resin selected from the group consisting of tetrafluoroethylene resin, trifluoroethylene resin, tetrafluoroethylene-hexafluoropropylene resin, vinyl fluoride resin, vinylidene fluoride resin, ethylene dichloride difluoride resin, and copolymers thereof.

3. The electrophotographic photosensitive member according to claim 1, wherein the fluorine-containing copolymer is a copolymer having a structural unit expressed by formula (1) and a structural unit expressed by formula (2): 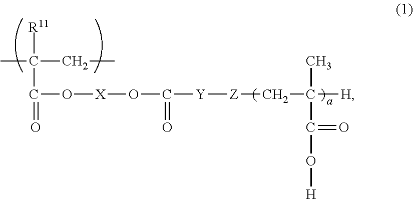
wherein in formulas (1), a represents an integer of 1 or greater; R¹¹, R¹², and R¹³ each represent one of a hydrogen atom and alkyl groups; X and Y each represent one of a single bond, a bonding group expressed by formula (3), or a bonding group expressed by formula (4); and Z represents one selected from the group consisting of a sulfur atom, an oxygen atom, a nitrogen atom, a single bond, and a bonding group expressed by formula (3), and 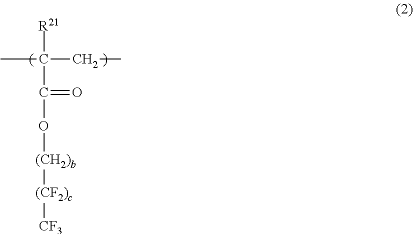
wherein in formula (2), b represents an integer of 0 or greater; c represents an integer in the range of 1 to 7; and R²¹ represents one of a hydrogen atom and alkyl groups,
wherein formulas (3) and (4) are: 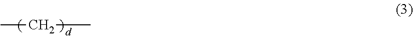
wherein in formulas (3), d represents an integer of 0 or greater, and 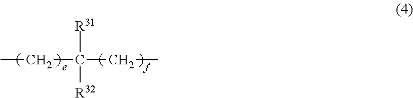
wherein in formula (4), e and f each represent an integer of 0 or greater; R³¹ and R³² each represent one selected from the group consisting of a hydrogen atom, a halogen atom, a hydroxy group, a substituted or unsubstituted alkyl group, and a substituted or unsubstituted aryl group.

4. The electrophotographic photosensitive member according to claim 1, wherein the fluorine-containing resin particles have an average primary particle size in the range of 0.05 μm to 0.85 μm.

5. The electrophotographic photosensitive member according to claim 1, wherein the proportion in the charge transport layer of the fluorine-containing copolymer to the fluorine-containing resin particles is in the range of 1.0% by mass to 10.0% by mass.

6. The electrophotographic photosensitive member according to claim 3, wherein integer c in formula (2) is in the range of 2 to 6.

7. The electrophotographic photosensitive member according to claim 3, wherein integer c in formula (2) is in the range of 4 to 6.

8. The electrophotographic photosensitive member according to claim 1, wherein the fluorine-containing copolymer has a weight average molecular weight Mw in the range of 60,000 to 400,000, and the ratio Mw/Mn of the weight average molecular weight Mw thereof to the number average molecular weight Mn thereof is in the range of 2.0 to 8.0.

9. The electrophotographic photosensitive member according to claim 1, wherein the proportion of the amide compound to the gallium phthalocyanine in the gallium phthalocyanine crystal is in the range of 0.1% by mass to 3.0% by mass.

10. The electrophotographic photosensitive member according to claim 1, wherein the proportion of the amide compound to the gallium phthalocyanine in the gallium phthalocyanine crystal is in the range of 0.3% by mass to 1.5% by mass.

11. The electrophotographic photosensitive member according to claim 1, wherein the gallium phthalocyanine crystal is one of a hydroxy gallium phthalocyanine crystal and a chlorogallium phthalocyanine crystal.

12. A method for manufacturing an electrophotographic photosensitive member including a support member, a charge generating layer, and a charge transport layer in that order, the method comprising:
forming the charge generating layer by forming a coating film of a coating liquid containing a gallium phthalocyanine crystal containing therein at least one amide compound selected from the group consisting of N-methylformamide, N-propylformamide, and N-vinylformamide, and drying the coating film; and
forming a charge transport layer by forming a coating film of a coating liquid containing fluorine-containing resin particles dispersed therein by a fluorine-containing copolymer, and drying the coating film.

13. The method according to claim 12, wherein the proportion in the charge transport layer of the fluorine-containing copolymer to the fluorine-containing resin particles is in the range of 1.0% by mass to 10.0% by mass.

14. A process cartridge capable of being removably attached to an electrophotographic apparatus, the process cartridge comprising:
an electrophotographic photosensitive member including a support member, a charge generating layer, and a charge transport layer in that order; and
at least one device selected from the group consisting of a charging device, a developing device, and a cleaning device,
wherein electrophotographic photosensitive member and the at least one device are held in one body,
wherein the charge generating layer contains a gallium phthalocyanine crystal containing therein at least one amide compound selected from the group consisting of N-methylformamide, N-propylformamide, and N-vinylformamide, and
wherein the charge transport layer contains fluorine-containing resin particles and a fluorine-containing copolymer.

15. An electrophotographic apparatus comprising:
an electrophotographic photosensitive member including a support member, a charge generating layer, and a charge transport layer in that order;
a charging device;
an exposure device;
a developing device; and
a transfer device,
wherein the charge generating layer contains a gallium phthalocyanine crystal containing therein at least one amide compound selected from the group consisting of N-methylformamide, N-propylformamide, and N-vinylformamide, and
wherein the charge transport layer contains fluorine-containing resin particles and a fluorine-containing copolymer.
